(19) United States
(12) Patent Application Publication
(10) Pub. No.: US 2019/0057043 A1
(43) Pub. Date: Feb. 21, 2019

(54) HOT ENCRYPTION SUPPORT PRIOR TO STORAGE DEVICE ENROLMENT

(71) Applicant: INTERNATIONAL BUSINESS MACHINES CORPORATION, Armonk, NY (US)

(72) Inventors: Zah Barzik, Rishon LeZion (IL); Ronen Gazit, Tel Aviv (IL); Ofer Leneman, Kfar Saba (IL); Amit Margalit, Hod-Hasharon (IL)

(21) Appl. No.: 15/679,382

(22) Filed: Aug. 17, 2017

(51) Int. Cl. G06F 12/14; H04L 29/06

(52) U.S. Cl. CPC G06F 12/1408; G06F 2212/1052; H04L 63/0853; H04L 63/061

(57) ABSTRACT

A storage system (system) includes two storage devices (first device and second device). The first device stores encrypted user data prior to being enrolled with an external key server. The system generates a device access key (DAK) and a device encryption key (DEK) used to encrypt such user data and encrypts the DEK with the DAK to generate an encrypted DEK (DEK′). The system stores DEK′ in the second device and stores DAK in the first device. The system enrolls the first device with the key server and receives a secure encryption key (SEK). The system obtains DEK′ and DAK, which are subsequently deleted from the first and second storage device, respectively. A new DAK′ is generated utilizing SEK and a first device identifier. The DEK is encrypted utilizing DAK′ to form DEK″. The system indicates DAK′ is an externally derived key and saves DEK″ to the second device.

### FIELD OF THE INVENTION

Embodiments of the invention generally relate to computer systems and more particularly to a storage system that includes a scheme for supporting hot encryption of data stored upon a storage device prior to the storage device being enrolled with and the storage system being provided an encryption key for the storage device from an external key server.

### DESCRIPTION OF THE RELATED ART

Hot encryption refers to the practice of a storage system constantly encrypting data that is stored to a storage device. Some storage systems encrypt data with the aid of an external device, such as a key server, that provides an encryption key. However, prior to obtaining the encryption key from the external device, the storage device may be required to store data. Therefore, some storage systems may not have the capability of hot encrypting that data prior to the storage system enrolling the storage device and obtaining the encryption key for the storage device from the external device.

### SUMMARY

In an embodiment of the present invention a storage system includes a first storage device that stores user data received by one or more computers communicatively connected to the storage system, a second storage device that does not store any user data received by any of the one or more computers communicatively connected to the storage system, a processor, and a memory. The memory includes program instructions that are readable to cause the processor to, prior to the first storage device being enrolled with an external key server and the storage system resultantly receiving a secure encryption key (SEK) assigned to the first storage device from the external key server, encrypt the user data stored upon the first storage device utilizing a device access key (DAK) and a device encryption key (DEK) by encrypting the DEK with the DAK to generate a DEK′, storing the DAK within the first storage device, storing the DEK′ within the second storage device, subsequently receiving the DAK from the first storage device and subsequently receiving the DEK′ from the second storage device, subsequently decrypting the DEK′ with the DAK to recover the DEK, and encrypting the user data stored upon the first storage device utilizing the DEK. The memory further includes program instructions that are readable to cause the processor to, subsequent to the first storage device being enrolled with the external key server and the storage system resultantly receiving the SEK assigned to the first storage device from the external key server, receive the DAK from the first storage device and receive the DEK′ from the second storage device, decrypt the DEK′ with the DAK to recover the DEK, generate a DAK′ from the first the SEK and a storage device identifier associated with the first storage device, encrypt the DEK with the DAK′ to generate a DEK″, and store the DEK″ within the second storage device.

A computer program product for a storage system hot encrypting user data stored upon a first storage device that stores user data received by one or more computers communicatively connected to the storage system, prior to the first storage device being enrolled with an external key server and resultantly being assigned a secure access key (SEK) is presented. The computer program product includes computer readable storage medium having program instructions embodied therewith. The program instructions are readable to cause a processor to, prior to the first storage device being enrolled with the external key server and resultantly being assigned the SEK, encrypt user data stored upon the first storage device utilizing a first device access key (DAK) and a device encryption key (DEK) by encrypting the DEK with the DAK to generate a DEK′, storing the DAK within the first storage device, storing the DEK′ within a second storage device that does not store any user data received by any of the one or more computers communicatively connected to the storage system, subsequently receiving the DAK from the first storage device and subsequently receiving the DEK′ from the second storage device, subsequently decrypting the DEK′ with the DAK to recover the DEK, and encrypting the user data stored upon the first storage device utilizing the DEK. The program instructions are further readable to cause a processor to, subsequent to the first storage device being enrolled with the external key server and resultantly being assigned the SEK, receive the DAK from the first storage device and receive the DEK′ from the second storage device, decrypt the DEK′ with the DAK to recover the DEK, generate a DAK′ from the first the SEK and a storage device identifier associated with the first storage device, encrypt the DEK with the DAK′ to generate a DEK″, and store the DEK″ within the second storage device.

In yet another embodiment of the present invention, a hot encryption method of a storage system is presented. The storage system includes a first storage device that stores user data received by one or more computers communicatively connected to the storage system and a second storage device that does not store any user data received by any of the one or more computers communicatively connected to the storage system. The method includes, prior to the first storage device being enrolled with an external key server and the storage system resultantly receiving a secure encryption key (SEK) assigned to the first storage device from the external key server, encrypting the user data stored upon the first storage device utilizing a first device access key (DAK) and a device encryption key (DEK). The user data is encrypted by encrypting the DEK with the DAK to generate a DEK′, storing the DAK within the first storage device, storing the DEK′ within the second storage device, subsequently receiving the DAK from the first storage device and subsequently receiving the DEK′ from the second storage device, subsequently decrypting the DEK′ with the DAK to recover the DEK, and encrypting the user data stored upon the first storage device utilizing the DEK. The method further includes, subsequent to the first storage device being enrolled with the external key server and the storage system resultantly receiving the secure encryption key (SEK) from the external key server, receiving the DAK from the first storage device and receiving the DEK′ from the second storage device, decrypting the DEK′ with the DAK to recover the DEK, generating a DAK′ from the first the SEK and a storage device identifier associated with the first storage device, encrypting the DEK with the DAK′ to generate a DEK″, and storing the DEK″ within the second storage device.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary computer system connected to a storage system by a network, according to various embodiments of the invention.

FIG. 2 illustrates a high-level block diagram of an exemplary storage system connected to a computer and to a key server by a network, according to various embodiments of the invention.

FIG. 3 illustrates a high-level block diagram of an exemplary key server connected to a storage system by a network, according to various embodiments of the invention.

FIG. 4 illustrates exemplary storage devices within a storage system, according to various embodiments of the invention.

FIG. 5 illustrates an exemplary method of a storage system generating and storing hot encryption keys, prior to the storage system enrolling with a key server, according to various embodiments of the invention.

FIG. 6 illustrates an exemplary method of a storage system encrypting user data with hot encryption keys, prior to the storage system enrolling with a key server, according to various embodiments of the invention.

FIG. 7 illustrates an exemplary method of a storage system generating and storing externally derived hot encryption keys, contemporaneous or subsequent to the storage system enrolling with a key server, according to various embodiments of the invention.

FIG. 8 illustrates an exemplary method of a storage system receiving and satisfying a request for decrypted user data that was hot encrypted prior to the storage system enrolling with a key server and receiving an external key generated by the key server that was generated subsequent to the encryption, according to various embodiments of the invention.

FIG. 9 illustrates an exemplary data structure that includes storage device identifier information and an associated encrypted device encryption key and that is stored within an assisting storage device within the storage system, according to various embodiments of the invention.

FIG. 10 illustrates an exemplary data structure containing storage device identifier information and an associated device access key and that is stored within an un-encrypted portion of a storage device within the storage system, according to various embodiments of the invention.

FIG. 11 illustrates an exemplary data structure that includes storage system identifier information, storage device identifier information, and an associated secure access key and that is stored within the key server, according to various embodiments of the invention.

FIG. 12 illustrates an exemplary data structure that includes storage device identifier information and an associated externally derived access key indicator and that is stored within the storage system, according to various embodiments of the invention.

### DETAILED DESCRIPTION

A storage system that supports hot encryption in software includes at least two storage devices. A first storage device stores user data that is to be encrypted by the storage system prior to, and after, the storage system enrolls the first storage device with an external key server and resultantly receives a secure access key (SEK) from the external key server associated with the first storage device. To provide for such encryption, the storage system generates a device access key (DAK) and a device encryption key (DEK). The storage system encrypts the DEK with the DAK to generate an encrypted DEK (DEK′). The storage system stores the DEK′ in a second storage device and stores the DAK in an un-encrypted storage portion of the first storage device.

Prior to the storage system enrolling the first storage device with, and obtaining the SEK for the first storage device from the external key server, the storage system encrypts the user data being stored upon the first storage device by the storage system obtaining the DEK′ from the second storage device and obtaining the DAK from the un-encrypted storage portion of the first storage device, decrypting the DEK′ with the DAK to recover the DEK, and encrypting the user data being stored upon the first storage device utilizing the DEK.

Contemporaneous with or subsequent to the storage system enrolling the first storage device with the key server and resultantly receiving the SEK for the first storage device, the storage system obtains the DEK′ from the second storage device and obtains the DAK from the un-encrypted storage portion of the first storage device and decrypts the DEK′ with the DAK to recover the DEK. Subsequently, the DEK′ is deleted from the second storage device and the DAK is deleted from the un-encrypted storage portion of the first storage device. The storage system generates a new DAK (DAK′) utilizing the SEK and a storage device identifier of the first storage device and encrypts the DEK utilizing the DAK′ to generate a newly encrypted DEK″. The storage system indicates the DAK′ is an externally derived access key so as to indicate that the DAK′ may be recalculated. The storage system also saves DEK″ to the second storage device.

The storage system may provide decrypted user data from the first storage device to a requestor that was hot encrypted prior to the first device being enrolled with the key server. The storage system obtains the SEK for the first storage device from the key server, obtains the DEK″ from the second storage device, and recalculates the DAK′. The storage system recalculates DAK′ from the SEK and the storage device identifier of the first storage device. Subsequently, the storage system decrypts DEK″ utilizing DAK′ to recover the DEK, decrypts the user data utilizing DEK, and provides the decrypted user data from the first device to the requestor.

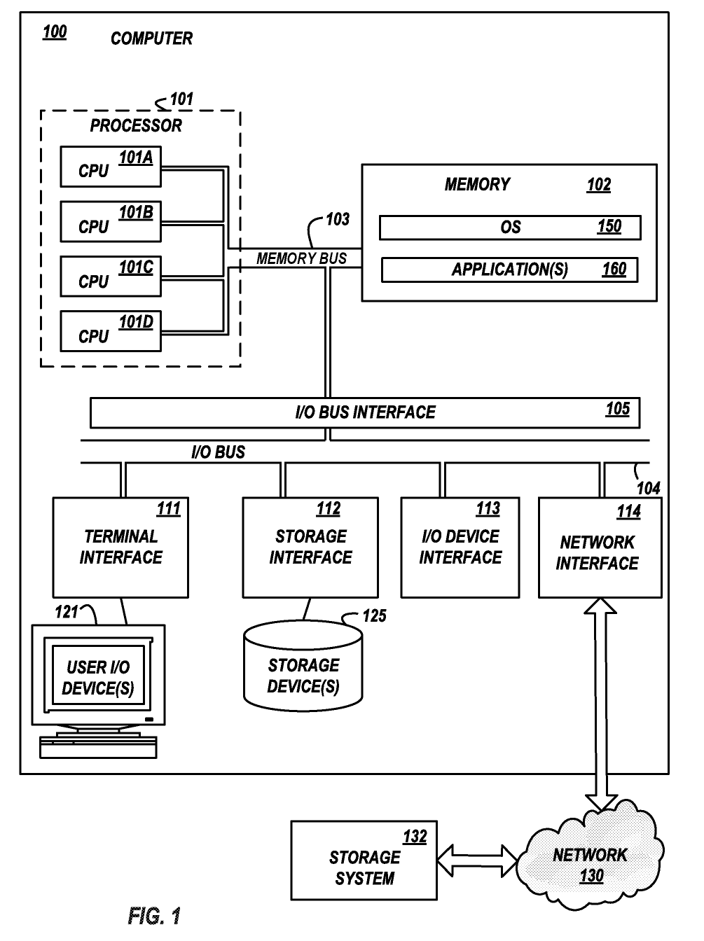

Referring to the Drawings, wherein like numbers denote like parts throughout the several views, FIG. 1 depicts a high-level block diagram representation of an exemplary computer 100 connected to a storage system 132 via a storage network 130. The term “computer” is used herein for convenience only, and in various embodiments, is a more general data handling device. The mechanisms and apparatus of embodiments of the present invention apply equally to any appropriate data handling device.

Computer 100 may include one or more processors 101, a main memory 102, a terminal interface 111, a storage interface 112, an I/O (Input/Output) device interface 113, and/or a network interface 114, all of which are communicatively coupled, directly or indirectly, for inter-component communication via a memory bus 103, an I/O bus 104, and an I/O bus interface unit 105. The computer 100 contains one or more general-purpose programmable central processing units (CPUs) 101A, 101B, 101C, and 101D, herein generically referred to as the processor 101. In an embodiment, the computer 100 contains multiple processors typical of a relatively large system; however, in another embodiment the computer 100 may alternatively be a single CPU system. Each processor 101 executes instructions stored in the main memory 102 and may comprise one or more levels of on-board cache.

In an embodiment, the main memory 102 may comprise a random-access semiconductor memory or storage medium for storing or encoding data and programs. In another embodiment, the main memory 102 represents the entire virtual memory of the computer 100, and may also include the virtual memory of other computer systems coupled to the computer 100 or storage systems 132 connected to the computer 100 via the storage network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes an operating system 150 and one or more applications 160. Although the operating system 150, application(s) 160, etc. are illustrated as being contained within the memory 102 in the computer 100, in other embodiments some or all of them may be on different computer systems and may be accessed remotely, e.g., via a network. The computer 100 may use virtual addressing mechanisms that allow the programs of the computer 100 to behave as if they only have access to a large, single storage entity instead of access to multiple, smaller storage entities.

Thus, while operating system 150 and application(s) 160 are illustrated as being contained within the main memory 102, these elements are not necessarily all completely contained in the same memory at the same time. Further, although operating system 150 and application 160 are illustrated as being separate entities, in other embodiments some of them, portions of some of them, or all of them may be packaged together.

In an embodiment, operating system 150 and/or application(s) 160 comprise program instructions or statements that are called and executed by the processor 101 to generate user data that is stored in storage system 132.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage devices and/or other I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer 100, and may receive output data via the user output devices. For example, a user interface may be presented via the user I/O device 121, such as displayed on a display device, played via a speaker, or printed via a printer.

The storage interface unit 112 supports the attachment of one or more storage devices 125. In an embodiment, the storage devices 125 are rotating magnetic disk drive storage devices, flash drive storage devices, or similar other types of storage device(s). The contents of the main memory 102, or any portion thereof, may be stored to and retrieved from the storage device(s) 125, as needed. The local storage devices 125 generally have a slower access time than does the memory 102, meaning that the time needed to read and/or write data from/to the memory 102 is less than the time needed to read and/or write data from/to for the local storage device(s) 125.

The I/O device interface unit 113 provides an interface to any of various other input/output devices or devices of other types, such as printers or fax machines. The network interface unit 114 provides one or more communications paths from the computer 100 to other data handling devices, such as storage system 132; such paths may comprise, e.g., one or more storage networks 130. Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 105 and the I/O bus 104 are shown as single respective units, the computer 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

I/O interface unit(s) may contain electronic components and logic to adapt or convert data of one protocol on I/O bus 104 to another protocol on another bus. Therefore, network interface 114 may connect a wide variety of devices to computer 100 and to each other such as, but not limited to, tape drives, optical drives, printers, disk controllers, workstations using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics, etc.

Though shown as distinct entities, the multiple I/O interface units 111, 112, 113, and 114 or the functionality of the I/O interface units 111, 112, 113, and 114 may be integrated into the same device.

In various embodiments, the computer 100 is a multi-user mainframe computer system, a single-user system, or a server computer or similar device that has little or no direct user interface, but receives requests from other computer systems (clients). In other embodiments, the computer 100 is implemented as a desktop computer, portable computer, laptop or notebook computer, tablet computer, pocket computer, telephone, smart phone, pager, automobile, teleconferencing system, appliance, or any other appropriate type of electronic device.

Network 130 is a storage network, which is a network which provides computer 100 access (i.e. read and/or write) to data stored within storage system 130. In this embodiment, network 130 is generally any high-performance network whose primary purpose is to enable storage system 132 to provide storage operations to computer 100 and may be primarily used to enhance storage devices, such as disk arrays, tape libraries, optical jukeboxes, etc., within the storage system 132 to be accessible to computer 100 so that storage devices within storage system 132 appear to the operating system 150 of computer 100 as locally attached devices. In other words, the storage system 132 may appear to the OS 150 as being a local storage device 125. A benefit of this type of storage network is that the amount of storage resource within storage system 132 may be treated as a pool of resources that can be centrally managed and allocated on an as-needed basis. Further, this type of storage network may be highly scalable because additional storage capacity can be added to storage system 132, as required.

Application 160 and/or OS 150 of computer 100 can be connected to the storage system 132, via the network 130. For example, any application 160 and or OS 150 running on computer 100 can access shared or distinct storage devices within storage system 132. When computer 100 wants to access a storage device within storage system 132 via the network 130, computer 100 sends out an I/O access request to the storage system 132. Network 130 may further include cabling, host bus adapters (HBAs), and switches. Each switch and storage system 132 on the network 130 may be interconnected and the interconnections generally support bandwidth levels that can adequately handle peak data activities. In certain implementations, network 130 may be a Fibre Channel SAN, iSCSI SAN, or the like.

FIG. 1 is intended to depict representative major components of the computer 100. Individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program instructions implementing e.g. upon computer system 100 according to various embodiments of the invention may be implemented in a number of manners, including using various computer applications, routines, components, programs, objects, modules, data structures, etc., and are referred to hereinafter as “computer programs, “or simply “programs.”

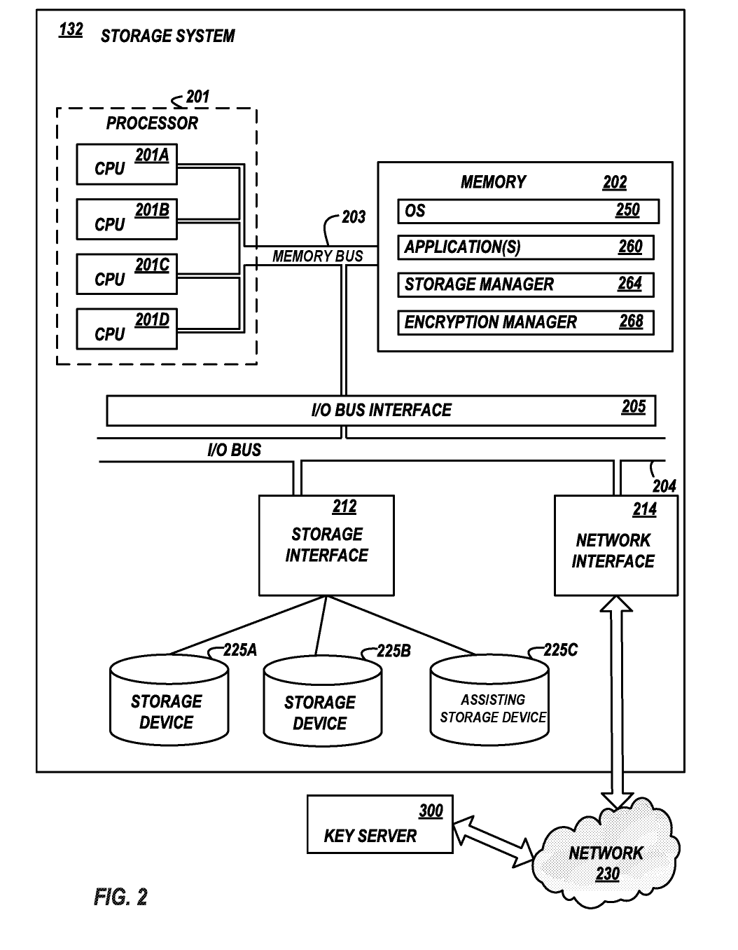

FIG. 2 illustrates a high-level block diagram storage system 132 connected to a key server 300 by network 230, according to various embodiments of the invention. Storage system 132 may include one or more processors 201, a main memory 202, a storage interface 212 and a network interface 214, which are communicatively coupled, directly or indirectly, for inter-component communication via a memory bus 203, an I/O bus 204, and an I/O bus interface unit 205. The storage system 100 may contain one or more general-purpose programmable central processing units (CPUs) 201A, 201B, 201C, and 201D, herein generically referred to as the processor 201. In an embodiment, the storage system 132 contains multiple processors typical of a relatively large system; however, in another embodiment the storage system 132 may alternatively be a single CPU system. Each processor 201 executes instructions stored in the main memory 202 and may comprise one or more levels of on-board cache.

In an embodiment, the main memory 202 may comprise a random-access semiconductor memory or storage medium for storing or encoding data and programs. In another embodiment, the main memory 202 represents the entire virtual memory of the storage system 132, and may also include the virtual memory of other storage systems coupled to the computer 100 or connected to the storage system 132 via network 130 or 230. The main memory 202 is conceptually a single monolithic entity, but in other embodiments the main memory 202 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 202 stores or encodes a storage system operating system 250 and one or more applications 2610, such as a storage manager 264 and an encryption manager 268. Although the operating system 250, application(s) 160, etc. are illustrated as being contained within the memory 202 in the storage system 132, in other embodiments some or all of them may be on different storage systems and may be accessed remotely, e.g., via a network. The storage system 132 may use virtual addressing mechanisms that allow the programs of the storage system 132 to behave as if they only have access to a large, single storage entity instead of access to multiple, smaller storage entities.

Thus, while operating system 250 and application(s) 260 are illustrated as being contained within the main memory 202, these elements are not necessarily all completely contained in the same memory at the same time. Further, although operating system 250 and application 260 are illustrated as being separate entities, in other embodiments some of them, portions of some of them, or all of them may be packaged together.

In an embodiment, operating system 250 and/or application(s) 260 comprise program instructions or statements that are called and executed by the processor 201 to store user data generated by computer 100 within storage device(s) 225 of the storage system 132 and to provide user data to computer 100 that was stored upon storage device(s) 225.

The memory bus 203 provides a data communication path for transferring data among the processor 201, the main memory 202, and the I/O bus interface unit 205. The I/O bus interface unit 205 is further coupled to the system I/O bus 204 for transferring data to and from the various I/O units. The I/O bus interface unit 205 communicates with multiple I/O interface units 212, 214, or the like, which are also known as I/O processors (IOPs) or I/O adapters (IOAs), through the system I/O bus 204. The I/O interface units support communication with a variety of storage devices 225. For example, the storage interface unit 112 supports the attachment of one or more storage devices 225a, 225b, and 225c, herein referred to generically as storage devices 225. In an embodiment, the storage devices 225 are rotating magnetic disk drive storage devices, flash drive storage devices, or similar other types of storage device(s).

In an embodiment, the storage devices 225 are segregated into two separate types: (a) those storage devices that contain user data of any computer 100 that is connected to the storage system 132 by network 130 and (b) those storage devices that do not contain user data of any computer 100 that is connected to the storage system 132 by network 130. For example, storage device 225a and storage device 225b are storage devices of the first type since storage device 225a and storage device 225b contain user data of any computer 100 that is connected to the storage system 132 by network 130 and storage device 225c is a storage device of the second type since storage device 225c does not contain user data of any computer 100 that is connected to the storage system 132 by network 130. The one or more storage devices of the second type that do not contain user data of any computer 100 that are connected to the storage system 132 by network 130 are hereby referred herein to as an assisting storage device and/or assisting storage devices.

The contents of the main memory 202, or any portion thereof, may be stored to and retrieved from the storage device(s) 225, as needed. The local storage devices 225 generally have a slower access time than does the memory 202, meaning that the time needed to read and/or write data from/to the memory 202 is less than the time needed to read and/or write data from/to for the local storage device(s) 225.

Although the memory bus 203 is shown in FIG. 1 as a relatively simple, single bus structure providing a direct communication path among the processors 201, the main memory 202, and the I/O bus interface 205, in fact the memory bus 203 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 205 and the I/O bus 204 are shown as single respective units, the storage system 132 may, in fact, contain multiple I/O bus interface units 205 and/or multiple I/O buses 204. While multiple I/O interface units are shown, which separate the system I/O bus 204 from various communications paths running to the various storage devices 225, in other embodiments some or all of the storage devices 225 are connected directly to one or more system I/O buses 204.

Network interface 214 may connect a wide variety of devices, such as numerous computers 100 and may further connect another storage system to storage system 132, and may further connect the storage system 132 to other devices such as, but not limited to, tape drives, optical drives, printers, disk controllers, workstations, etc. Network interface 214 is a network interface that connects storage system 132 to computer 100 via a storage network 130 and that connects storage system 132 to a key server 300 via a communication network 230.

Though shown as distinct entities, the multiple I/O interface units 212 and 214 or the functionality of the I/O interface units 212 and 214 may be integrated into the same entity.

In an embodiment, network 230 is a communication network that connects the storage system 132 to another data handling device, such as a key server 300, and be any suitable communication network or combination of networks and may support any appropriate protocol suitable for communication of data and/or code to/from the storage system 132. In various embodiments, the communication network may represent a data handling device or a combination of data handling devices, either connected directly or indirectly to the storage system 132. In another embodiment, the communication network may support wireless communications. In another embodiment, the communication network may support hard-wired communications, such as a telephone line or cable. In another embodiment, the communication network may be the Internet and may support IP (Internet Protocol). In another embodiment, the communication network is implemented as a local area network (LAN) or a wide area network (WAN). In another embodiment, the communication network is implemented as a hotspot service provider network. In another embodiment, the communication network is implemented an intranet. In another embodiment, the communication network is implemented as any appropriate cellular data network, cell-based radio network technology, or wireless network. In another embodiment, the communication network is implemented as any suitable network or combination of networks.

Storage manager 264 controls computer 100 access (i.e. read and/or write) to data stored within storage system 132. In this embodiment, storage manager 264 enables storage system 132 to provide storage operations to computer 100 and may be primarily used to enhance storage devices 225, such as disk arrays, tape libraries, optical jukeboxes, etc., within the storage system 132 to be accessible to computer 100 so that storage devices 225 within storage system 132 appear to the operating system 150 of computer 100 as locally attached devices. In other words, the storage manager 264 allows the storage system 132 to appear to the OS 150 as being a local storage device 125. In an embodiment, computer 100 requests to write data as if it was being written to a local storage device 125. This request includes the data and an address that identifies a location within computer 100. The storage manager 264 obtains the write request, assigns an address which identifies a location within storage system 132 to the address that identifies a location within computer 100 and stores the data at the location within storage system 132. When computer 100 intends to read this data, the computer 100 requests the user data along with the location within computer 100, storage manager 264 receives the read request, identifies the location within computer 100, identifies the associated location within storage system 132 to which the data was stored, obtains the data from the location within storage system 132, and provides the user data to computer 100.

For storage system 132 to provide hot encryption of data stored upon a storage device prior to enrolling the storage device with an external key server and the key server, resultantly, providing the storage system the SEK for the storage device, encryption manager 268 generates a DAK and DEK for a particular storage device (e.g. storage device 225a) that contains user data. The encryption manager 268 may encrypt the user data contemporaneous with or subsequent to the generation of the DAK and the DEK. If the encryption manager encrypts the user data subsequent to the generation of the DAK and the DEK, encryption manager 268 encrypts the DEK with the DAK to generate an encrypted DEK (DEK′). Encryption manager 268 stores the DEK′ in the assisting storage device 225c and stores the DAK in an un-encrypted storage portion of the particular storage device (e.g. storage device 225a). For clarity, in one implementation, there is a unique DEK and unique DAK generated and associated with the particular storage device. For example, storage device 225a is associated with a unique DEK and DAK and storage device 225b is associated with a different unique DEK and DAK.

Prior to the storage system 132 enrolling the particular storage device (e.g., storage device 225a) with, and obtaining a secure access key (SEK) from, key server 300, encryption manager 268 encrypts the user data upon the storage device. If the DEK is in memory 202 (e.g, encryption manager 268 encrypts the user data contemporaneous with to the generation of the DAK and the DEK, or the like) encryption manager 268 encrypts the user data upon the storage device utilizing the DEK. However, to encrypt the user data of the particular storage device (e.g., storage device 225a), subsequent to the initial generation of the DEK and DAK, encryption manager 268 may need to recall the DEK′ and the DAK to recover the DEK. For example, encryption manager 268 obtains the DEK′ from the assisting storage device 225c and obtains the DAK from the un-encrypted storage portion of the particular storage device (e.g., storage device 225a). Subsequently, encryption manager 268 decrypts the DEK′ with the DAK to recover the DEK and encrypts the user data upon the particular storage device (e.g., storage device 225a) utilizing the DEK.

For clarity, in one implementation, there is a unique SEK generated and associated with the particular storage device. For example, storage device 225a is associated with a unique SEK and storage device 225b is associated with a different unique SEK. In another implementation, there is a unique SEK generated and associated with each storage device in a particular storage system 132. For example, storage device 225a is associated with a unique SEK and storage device 225b is associated with the same SEK.

Contemporaneous with or subsequent to the storage system enrolling storage device (e.g., storage device 225a) with key server 300 and resultantly receiving the SEK from key server 300, the encryption manager 268 obtains the DEK′ from the assisting storage device 225c and obtains the DAK from the un-encrypted storage portion of storage device (e.g., storage device 225a). Encryption manager 268 then decrypts the DEK′ with the DAK to recover the DEK. Subsequently, the DEK′ is deleted from the assisting storage device 225c and the DAK is deleted from the un-encrypted storage portion of the first storage device (e.g., storage device 225a). Encryption manager 268 generates a new DAK (DAK′) utilizing the SEK and a storage device identifier of the particular storage device (e.g., storage device 225a) and encrypts the DEK utilizing the DAK′ to generate a newly encrypted DEK″. Encryption manager 268 indicates the DAK′ is an externally derived access key so as to indicate that the DAK′ may be recalculated and encryption manager 268 saves DEK″ to the assisting storage device 225c.

Storage manager 264 provides decrypted user data from storage device (e.g., storage device 225a) to a requestor (e.g., computer 100, or the like) that was hot encrypted prior to storage device (e.g., storage device 225a) being enrolled with the key server 300. Initially, storage manager 264 sends a storage device identifier that corresponds with the particular storage device (e.g., storage device 225a), to encryption manager 268 that is implicated in a read request received by storage manager 264. The encryption manager 268 receives the storage device identifier and obtains the SEK from the key server 300 that corresponds with the storage device identifier, obtains the DEK″ from the assisting storage device 225c that corresponds with the storage device identifier, and recalculates the DAK′ utilizing the storage device identifier and the SEK. The encryption manager 268 then derives DEK from the DAK′ and the DEK″. Subsequently, encryption manager 268 decrypts the user data utilizing DEK, and storage manager 264 provides the decrypted user data from the particular storage device (e.g., storage device 225a) to the requestor.

For clarity, computer 100 may be connected to multiple key servers. In such implantations, a particular key server 300 may be deemed a primary key server.

FIG. 2 is intended to depict representative major components of the storage system 132. Individual components may have greater complexity than represented in FIG. 2, components other than or in addition to those shown in FIG. 2 may be present, and the number, type, and configuration of such components may vary. Several particular examples of such additional complexity or additional variations are disclosed herein; these are by way of example only and are not necessarily the only such variations. The various program instructions implementing e.g. upon storage system 132 according to various embodiments of the invention may be implemented in a number of manners, including using various computer applications, routines, components, programs, objects, modules, data structures, etc., and are referred to hereinafter as “computer programs, “or simply “programs.”

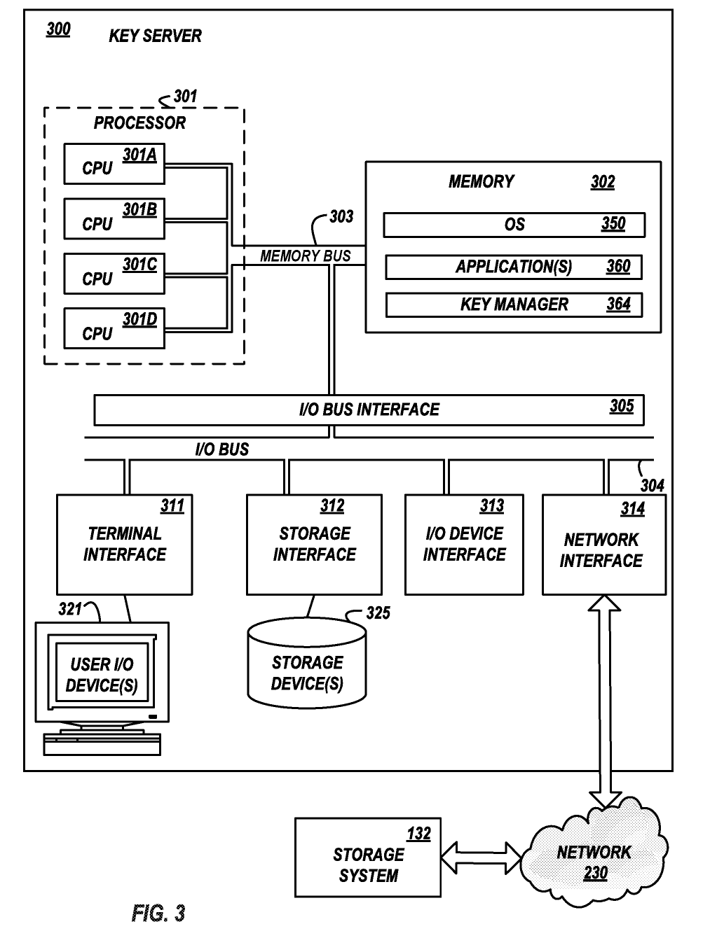

FIG. 3 illustrates a high-level block diagram of key server 300 connected to storage system 132 by network 230, according to various embodiments of the invention. The term “server” is used herein for convenience only, and in various embodiments, is a more general data handling device. The mechanisms and apparatus of embodiments of the present invention apply equally to any appropriate data handling device.

Key server 300 may include one or more processors 301, a main memory 302, a terminal interface 311, a storage interface 312, an I/O (Input/Output) device interface 313, and/or a network interface 314, all of which are communicatively coupled, directly or indirectly, for inter-component communication via a memory bus 303, an I/O bus 304, and an I/O bus interface unit 305. The key server 300 contains one or more general-purpose programmable central processing units (CPUs) 301A, 301B, 301C, and 301D, herein generically referred to as the processor 301. In an embodiment, the key server 300 contains multiple processors typical of a relatively large system; however, in another embodiment the key server 300 may alternatively be a single CPU system. Each processor 301 executes instructions stored in the main memory 302 and may comprise one or more levels of on-board cache.

In an embodiment, the main memory 302 may comprise a random-access semiconductor memory or storage medium for storing or encoding data and programs. In another embodiment, the main memory 302 represents the entire virtual memory of the key server 300, and may also include the virtual memory of other data handling systems coupled to the key server 300. The main memory 302 may be conceptually a single monolithic entity, but in other embodiments the main memory 302 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 302 stores or encodes an operating system 350 and one or more applications 360, such as key manager 364. Although the operating system 350, application(s) 360, etc. are illustrated as being contained within the memory 302 in the key server 300, in other embodiments some or all of them may be on different data handling systems and may be accessed by key server 300 remotely, e.g., via a network. The key server 300 may use virtual addressing mechanisms that allow the programs of the key server 300 to behave as if they only have access to a large, single storage entity instead of access to multiple, smaller storage entities.

Thus, while operating system 350 and application(s) 360 are illustrated as being contained within the main memory 302, these elements are not necessarily all completely contained in the same memory at the same time. Further, although operating system 350 and application 360 are illustrated as being separate entities, in other embodiments some of them, portions of some of them, or all of them may be packaged together.

In an embodiment, operating system 350 and/or application(s) 360 comprise program instructions or statements that are called and executed by the processor 301 to enroll a particular storage device 225a, 225b, or the like within storage system 132 and provide the storage system 132 the SEK that is associated with the particular storage device.

The memory bus 303 provides a data communication path for transferring data among the processor 301, the main memory 302, and the I/O bus interface unit 305. The I/O bus interface unit 305 is further coupled to the system I/O bus 304 for transferring data to and from the various I/O units. The I/O bus interface unit 305 communicates with multiple I/O interface units 311, 312, 313, and 314, which are also known as I/O processors (IOPs) or I/O adapters (IOAs), through the system I/O bus 304. The I/O interface units support communication with a variety of storage devices and/or other I/O devices. For example, the terminal interface unit 311 supports the attachment of one or more user I/O devices 321, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 321 and the key server 300, and may receive output data via the user output devices. For example, a user interface may be presented via the user I/O device 321, such as displayed on a display device, played via a speaker, or printed via a printer.

The storage interface unit 312 supports the attachment of one or more storage devices 325. In an embodiment, the storage devices 325 are rotating magnetic disk drive storage devices, flash drive storage devices, or similar other types of storage device(s). The contents of the main memory 302, or any portion thereof, may be stored to and retrieved from the storage device(s) 325, as needed. The local storage devices 325 generally have a slower access time than does the memory 302.

The I/O device interface unit 313 provides an interface to any of various other input/output devices or devices of other types, such as printers or fax machines. The network interface unit 314 provides one or more communications paths from the key server 300 to other data handling devices, such as storage system 132; such paths may comprise, e.g., one or more communication networks 230. Although the memory bus 303 is shown in FIG. 3 as a relatively simple, single bus structure providing a direct communication path among the processors 301, the main memory 302, and the I/O bus interface 305, in fact the memory bus 303 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 305 and the I/O bus 304 are shown as single respective units, the computer 300 may, in fact, contain multiple I/O bus interface units 305 and/or multiple I/O buses 304. While multiple I/O interface units are shown, which separate the system I/O bus 304 from various communications paths running to the various I/O devices, in other embodiments some or all of the I/O devices are connected directly to one or more system I/O buses.

I/O interface unit(s) may contain electronic components and logic to adapt or convert data of one protocol on I/O bus 304 to another protocol on another bus. Therefore, network interface 314 may connect a wide variety of devices to key server 300 Though shown as distinct entities, the multiple I/O interface units 311, 312, 313, and 314 or the functionality of the I/O interface units 311, 312, 313, and 314 may be integrated into the same device.

In various embodiments, the key server 300 is a multi-user mainframe computer system, a single-user system, or a server computer or similar device that has little or no direct user interface, but receives requests from other computer systems (clients). In other embodiments, the key server 300 is implemented as a desktop computer, portable computer, laptop or notebook computer, tablet computer, pocket computer, telephone, smart phone, pager, automobile, teleconferencing system, appliance, or any other appropriate type of electronic device.

Application(s) 360 and/or OS 350 of key server 300 can be connected to the storage system 132, via the network 230. For example, any application 360 and or OS 350 running on key server 300 can access shared or distinct storage devices within storage system 132. When key server 300 wants to access a storage device within storage system 132 via the network 230, computer 100 sends out an I/O access request to the storage system 132.

Key manager 364 generates and provides the SEK for the storage system 132 or for the particular storage device (i.e. storage device 225a) to storage system 132 and associates the generated SEK with a storage device identifier of the particular enrolled storage device (e.g., storage device 225a) of storage system 132.

FIG. 3 is intended to depict representative major components of the key server 300. Individual components may have greater complexity than represented in FIG. 3, components other than or in addition to those shown in FIG. 3 may be present, and the number, type, and configuration of such components may vary. Several particular examples of such additional complexity or additional variations are disclosed herein; these are by way of example only and are not necessarily the only such variations. The various program instructions implementing e.g. upon key server 300 according to various embodiments of the invention may be implemented in a number of manners, including using various computer applications, routines, components, programs, objects, modules, data structures, etc., and are referred to hereinafter as “computer programs, “or simply “programs.”

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

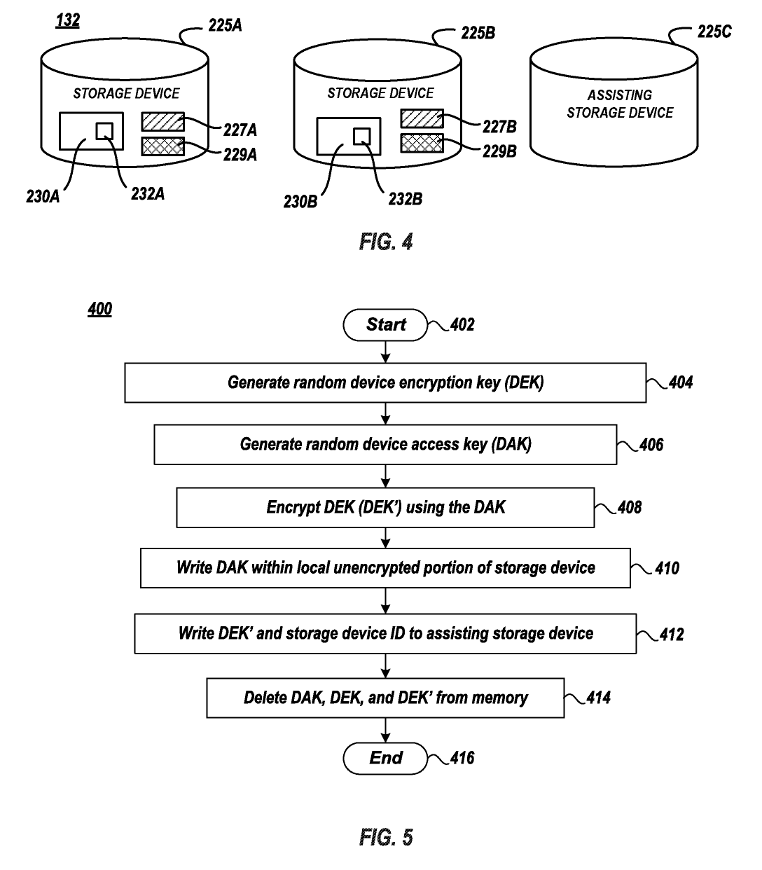

FIG. 4 illustrates exemplary storage devices 225 within storage system 132, according to various embodiments of the invention. The storage devices 225 of storage device 132 are segregated into two separate types: (a) those storage devices that contain user data of any computer 100 that is connected to the storage system 132 by network 130 (i.e. storage device 225a, storage device 225b) and (b) those storage devices that do not contain user data of any computer 100 that is connected to the storage system 132 by network 130 (i.e. storage device 225c). For clarity, computer(s) 100 are distinct data handling devices from key server 300.

Each storage device 225 may include both an un-encrypted storage portion 227, and an encrypted storage portion 229, respectively. For example, storage device 225a includes an un-encrypted storage portion 227a and encrypted storage portion 229a and storage device 225b includes an un-encrypted storage portion 227b and encrypted storage portion 229b. The un-encrypted storage portion 227 is a storage area of the storage device which is not encrypted by the techniques described herein (i.e. a portion of the storage device that is not encrypted by encryption manager 168). The encrypted storage portion 229 is a storage area of the storage device which is encrypted by the techniques described herein (i.e. a portion of the storage device that is encrypted by encryption manager 168).

In certain embodiments, one or more storage devices 225 may be self-encrypting storage devices. A self-encrypting storage device encrypts data stored thereupon itself with security key(s) generated therewithin as is known in the art. Such self-encryption by the self-encrypting storage devices is known to be transparent to a data handler, such as computer 100, encryption manager 168, or the like, outside of the self-encrypting device itself. When storage device 225a, storage device 225b, and/or storage device 225c are self-encrypting storage devices, each applicable storage device 225 may include a respective hardware storage manager 230 and hardware encryption circuit 232 to self-encrypt data as is known in the art.

FIG. 5 illustrates method 400 of storage system 132 generating and storing hot encryption keys, prior to the storage system 132 enrolling a storage device (e.g. storage device 225a, or the like) with key server 300, according to various embodiments of the invention. Method 400 begins at block 402 and continues with storage system 132 generating a random DEK that is to be used to encrypt user data from computer 100 within a storage device 225a local to storage system 132 (block 404). For example, encryption manager 268 generates a DEK that is to be used to encrypt user data received and stored by storage manager 264 to storage device 225a.

Method 400 continues with storage system 132 generating a random DAK that is to be used to encrypt the DEK and associates that DAK with the storage device identifier of storage device 225a. For example, encryption manager 268 generates a DAK that is to be used to encrypt the DEK and associates the generated DAK with the storage device identifier of storage device 225a.

Method 400 continues with storage system 132 encrypting the DEK with the DAK to generate an encrypted DEK (DEK′) (block 408). For example, encryption manager 268 generates the DEK′ by encrypting the DEK with the DAK. Method 400 continues with storage system 132 storing the DAK within the un-encrypted portion 227a of storage device 225a (block 410) and storing the DEK′ and associated storage device 225a identifier to assisting storage device 225c (block 412). For example, encryption manager 268 and/or storage manager 264 stores the DAK within un-encrypted portion 227a of storage device 225a and stores the DEK′ and associated storage device 225a identifier to an encryption management data structure within assisting storage device 225c that links the DEK′ and storage device 225a identifier. Method 400 continues with storage system 132 deleting, forgetting, destroying, or generally making the DEK′, DEK, and DAK unreadable from within memory 202 and/or from within processor 201. For example, encryption manager 268 deletes the DEK′, DEK, and DAK from within memory 202 and/or from within processor 201 since the DEK′ and DAK are recallable, respectively, from assisting storage device 225c and from un-encrypted portion 227a of storage device 225a and the DEK is able to be recalculated from the recalled DEK′ and DAK. Method 400 ends at block 416.

For clarity, method 400 may be sequentially repeated or contemporaneously repeated to generate, save, or the like, applicable hot encryption keys for other storage devices 225 of the first type within storage system 132 (e.g. storage device 225b).

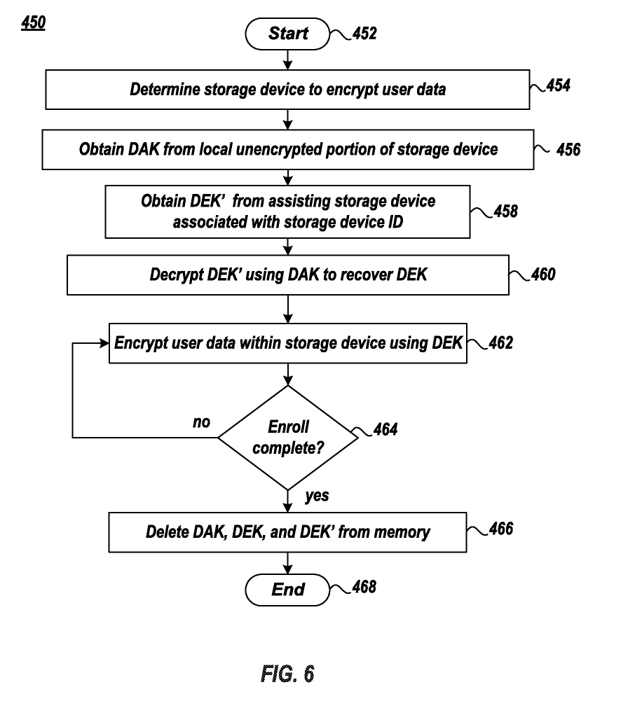

FIG. 6 illustrates method 450 of storage system 132 encrypting user data being written to a storage device 225a, 225b, or the like, within storage system 132 by computer 100 with hot encryption keys, prior to storage system 132 enrolling the storage device with key server 300, according to various embodiments of the invention. Method 450 beings at block 452 and continues with storage system determining the particular storage device (e.g., storage device 225a), to which to encrypt user data being stored thereupon (block 454). For example, encryption manager 268 determines that user data previously stored upon storage device 225a is to be encrypted. If the storage device is not a SED storage device, the user data previously stored upon storage device 225a may not be previously encrypted and may be located within the un-encrypted storage portion 227 of the storage device. If the storage device is a SED storage device, the user data previously stored upon storage device is previously encrypted by the SED storage device itself and is located within the encrypted storage portion 229 of the storage device.

Method 450 continues with storage system 132 obtaining the DAK and the DEK′. In one embodiment, encryption manager 268 may obtain the DAK and the DEK′ from local memory 202 and/or processor 201 if the DAK and the DEK′ is still located therewithin (i.e., the encryption manager 268 encrypts the user data contemporaneous with the generation of the DAK and DEK).

In an alternative embodiment, the storage system 132 obtains the DAK from the un-encrypted storage portion 227 of the storage device (e.g., storage device 225a) (block 456) and obtains the DEK′ from the assisting storage device 225c that is associated with the identifier of the storage device (block 458). For example, encryption manager 268 reads the DAK from the encrypted portion 227 of storage device 225a and encryption manager 268 access the data structure within assisting storage device 225c with a query including the device identifier to obtain the appropriate DEK′ that was previously generated and associated with storage device 225a.

Method 450 continues with storage system 132 decrypting the obtained DEK′ with the obtained DAK to recover the DEK (block 460). For example, encryption manager 268 decrypts the DEK′ with the DAK to recover the DEK. Method 450 continues with the storage system 132 encrypting the user data being stored upon the storage device with the DEK (block 462). For example, if the storage device is not a SED storage device, the user data previously stored upon storage device 225a, located within the un-encrypted storage portion 227 of the storage device 225a, is encrypted by encryption manager 268 with the DEK and if the storage device 225a is a SED storage device, the user data previously stored upon storage device 225a, located within the encrypted storage portion 229a of the storage device 225a, is encrypted by encryption manager 268 with the DEK.

Method 450 continues with determining whether the enrolment of the storage device is complete (block 464) and if not, method 450 returns to block 462, and if so, method 450 continues with storage system 132 deleting, forgetting, destroying, or generally making the DEK′, DEK, and DAK unreadable from within memory 202 and/or from within processor 201. For example, encryption manager 268 deletes the DEK′, DEK, and DAK from within memory 202 and/or from within processor 201 since the DEK′ and DAK are recallable, respectively, from assisting storage device 225c and from un-encrypted portion 227a of storage device 225a and the DEK is able to be recalculated from the recalled DEK′ and DAK. Method 450 ends at block 468.

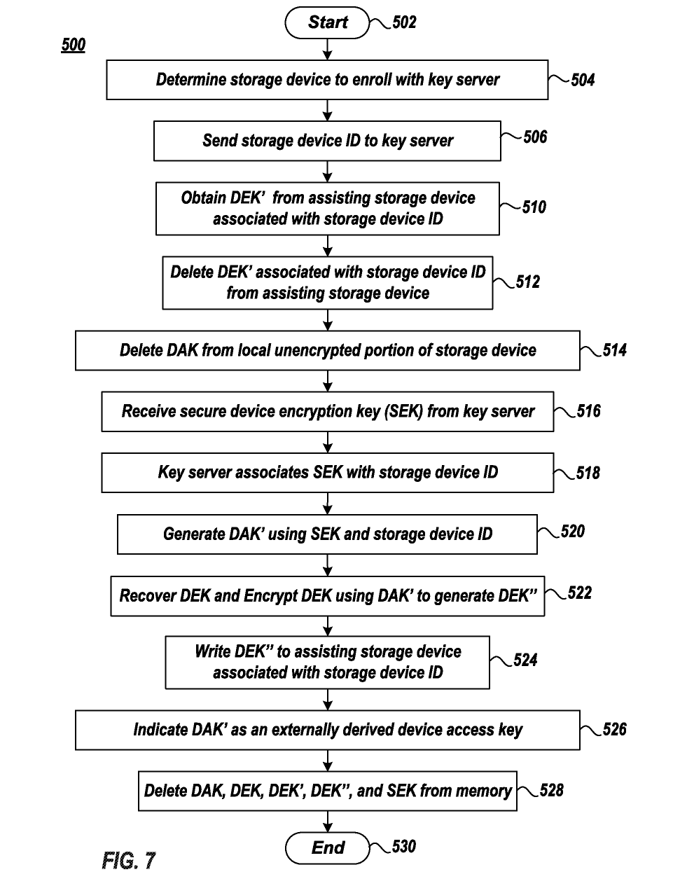

FIG. 7 illustrates method 500 of storage system 132 generating and storing externally derived hot encryption keys, contemporaneous or subsequent to the storage system 132 enrolling the storage device with key server 300, according to various embodiments of the invention. The term “enrolling” or the like is defined herein as the processes of the storage system 132 identifying a particular storage device 225 to protect utilizing an externally generated encryption key and the key server 300 generating and providing a unique SEK for the identified storage device 225 to storage system 132.

Method 500 begins at block 502 and continues with storage system 132 determining a storage device to enroll with key server 300 (block 504). For example, encryption manager 268 determines that storage device 225a will be enrolled with key server 300.

Method 500 continues with storage system 132 sending a storage device identifier associated with the storage device to be enrolled to key server 300 (block 506). For example, encryption manager 268 sends to key server 300 the storage device identifier associated with storage device 225a. The term, “device identifier” or the like is defined herein to be a code or expression, such as a globally unique identifier (GUID), serial number, worldwide name (WWN), or the like, that uniquely identifies a particular device (such as a storage device 225 or storage system 132) amongst the other devices.

Method 500 continues with storage system 132 obtaining the DEK′ from the assisting storage device 225c that is associated with the storage device identifier (block 510). For example, encryption manager 268 access the data structure within assisting storage device 225c with a query including the device identifier associated with storage device 225a to obtain the appropriate DEK′ that was previously generated and associated with storage device 225a.

Method 500 continues with storage system 132 deleting the DEK′ from the assisting storage device (block 512). For example, subsequent to encryption manager 268 obtaining the DEK′, the encryption manager 268 deletes or otherwise renders the DEK′ stored within the assisting storage device data structure as no longer readable from the assisting storage device 225c. In another example, the encryption manager 268 deletes the DEK′ by requesting that the assisting storage device 225c perform a hardware secure erase thereupon. In such embodiment, the assisting storage device 225c may be a self-encrypting storage device so as to perform the hardware secure erase procedure to delete the DEK′ therefrom.

Method 500 continues with storage system 132 deleting the DAK from the encrypted portion 227 of the storage device that is to be enrolled with key server 300 (block 514). For example, subsequent to encryption manager 268 obtaining the DAK, the encryption manager 268 deletes or otherwise renders the DAK stored within the encrypted portion 227 of the storage device 225a as no longer readable from the storage device 225a.

Method 500 continues with storage system 132 receiving the SEK from the key server 300 (block 516). For example, key server 300 generates a SEK for the storage device 225a associated with the received storage device identifier and sends the SEK to encryption manager 268 to enroll the storage device 225a.

Method 500 continues with key server 300 associating the generated SEK with the received storage device identifier within a data structure stored within key server 300. For example, key server 300 associates the SEK with the storage device identifier of storage device 225a within a data structure stored within memory 302, storage device 325, or the like, within key server 300.

Method 500 continues with storage system 132 generating a DAK′ from the SEK received from key server 300 and the storage device identifier of the storage device that is to be enrolled (block 520). For example, encryption manager 268 generates a DAK′ for storage device 225a from the SEK and the storage device identifier of storage device 225a and associates the DAK′ with the storage device identifier of storage device 225a.

Method 500 continues with storage system 132 recovering the DEK from the DEK′ and the DAK and encrypting the DEK using the DAK′ to generate DEK″ (block 522). For example, encryption manager 268 generates the DEK″ by encrypting the DEK with the DAK′. Method 500 continues with storage system 132 storing the DEK″ and associated storage device identifier to assisting storage device 225c (block 524). For example, encryption manager 268 and/or storage manager 264 stores the DEK″ and associated storage device 225a identifier to the data structure within assisting storage device 225c that links the DEK″ and storage device 225a identifier.

Method 500 continues by the storage system 132 indicating that the DAK′ of the storage device is an externally derived access key (i.e. an access key generated using an access key, such as the SEK, provided by an external data handling system, such as key server 300). For example, encryption manager 268 and/or storage manager 264 writes an indicator bit to a data structure within storage system 132 that links the indicator bit and storage device 225a identifier.

Method 500 continues with storage system 132 deleting, forgetting, destroying, or generally making the DEK″, DEK′, DEK, DAK′, DAK, and SEK unreadable from within memory 202 and/or from within processor 201. For example, encryption manager 268 deletes the DEK″, DEK′, DEK, DAK′, DAK, and SEK from within memory 202 and/or from within processor 201 because the DEK″ is recallable from assisting storage device 225c, the SEK is recallable from key server 300, the DAK′ is able to be recalculated using the SEK and the storage device identifier, and the DEK is able to be recalculated from the DEK″ and DAK′. Method 500 ends at block 530.

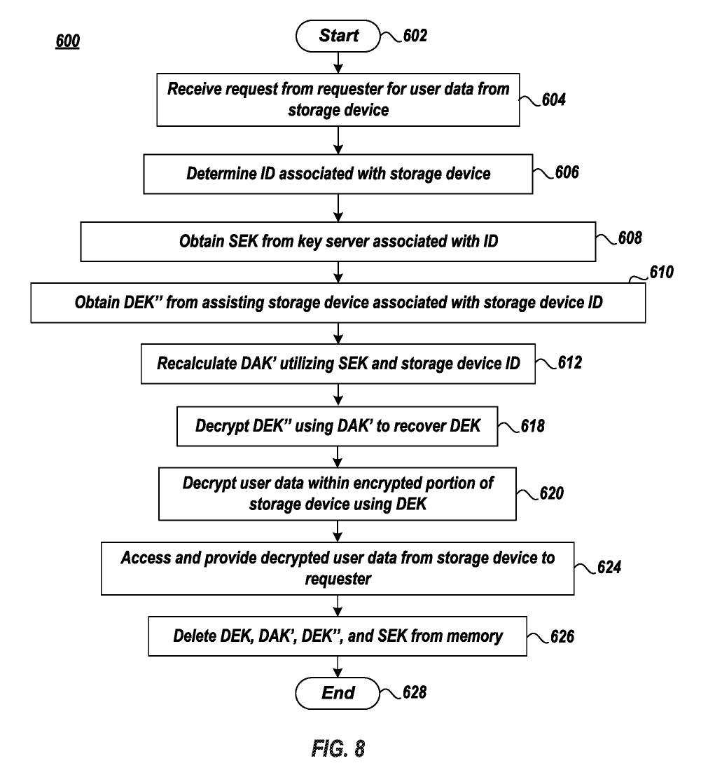

FIG. 8 illustrates method 600 of storage system 132 receiving and satisfying a read request for user data that was hot encrypted prior to the storage system 132 enrolling a storage device 225a, 225b with key server 300 and receiving the SEK associated with the storage device that was generated by the key server 300 subsequent to the encryption, according to various embodiments of the invention. Method 600 begins at block 602 and continues with storage system 132 receiving a request from a requestor data handling device, such as computer 100, for data from a storage device, within storage system 132 (block 604). For example, storage manager 264 receives a read request from computer 100 for data that is stored within the encrypted portion 229a of storage device 225a and sends a decrypt instruction to encryption manager 268 to decrypt such data utilizing the SEK.

Method 600 continues with storage system 132 determining the appropriate storage device identifier of the storage device or a storage system identifier of the storage system 132 that is implicated by the read request (block 606). For example, encryption manager 268 determines that storage device 225a contains the data that is implicated by the read request and determines the storage device identifier (225a-ID) that corresponds with the storage device 225a or determines the strorage system identifier (132-ID) that corresponds with the storage system 132 that houses storage device 225a.

Method 600 continues with the storage system 132 obtaining the appropriate SEK from key server 300 that corresponds with the identifier (block 608). For example, encryption manager 268 sends a SEK request along with the storage device identifier 225a-ID to key server 300 and key server 300 returns the appropriate SEK that is linked to the storage device identifier 225a-ID.

Method 600 continues with storage system 132 obtaining the DEK″ associated with the appropriate storage device identifier from the assisting storage device 225c (block 610). For example, encryption manager 268 queries the data structure within the assisting storage device 225c with the storage device identifier 225a-ID and obtains the appropriate SEK″ that is linked to the storage device identifier 225a-ID.

Method 600 continues with storage system 132 recalculating the DAK′ utilizing the SEK and the appropriate storage device identifier (block 612). For example, encryption manager 268 determines the prior logic that was used to generate the DAK′ with the SEK by utilizing the storage device identifier 225a-ID as a logic identifier and utilizes that identified logic and the SEK to derive the DAK′.

Method 500 continues with storage system decrypting the DEK″ using the DAK′ to recover the DEK (block 618). For example, encryption manager 268 decrypts the DEK″ utilizing the DAK′ to recover the DEK.

Method 600 continues with the storage system decrypting the applicable data implicated by the read request which is stored within the encrypted portion 229 of the storage device utilizing the DEK (block 620). For example, encryption manager 268 decrypts the user data that is implicated by the read request and which is stored within the encrypted portion 229a of storage device 225a. Such decryption is generally done at the storage system 132 level, meaning, that if the storage device is not a self-encrypting device the data that is stored within the encrypted portion 229a is decrypted by storage system 132; and if the storage device is a self-encrypting device the data that is stored within the encrypted portion 229a is decrypted by storage system 132 and decrypted by the self-encrypting storage device itself.

In some implementations, for example, in those embodiments where the storage device 225a which stores data implicated by the read request is a self-encrypting device, the self-encrypting device, itself, also transparently decrypts the applicable data using its own generated security key(s) as is known in the art so as to provide unencrypted data therefrom.

Method 600 continues with storage system 132 accessing the applicable decrypted data implicated in the read request and providing the decrypted data to the requesting data handling device (block 624). For example, storage manager 264 reads the appropriate decrypted data that is implicated by the read request and provides such data to computer 100.

Method 600 continues with storage system 132 deleting, forgetting, destroying, or generally making the DEK″, DEK, DAK′, and SEK unreadable from within memory 202 and/or from within processor 201 (block 626). Method 600 ends at block 628.

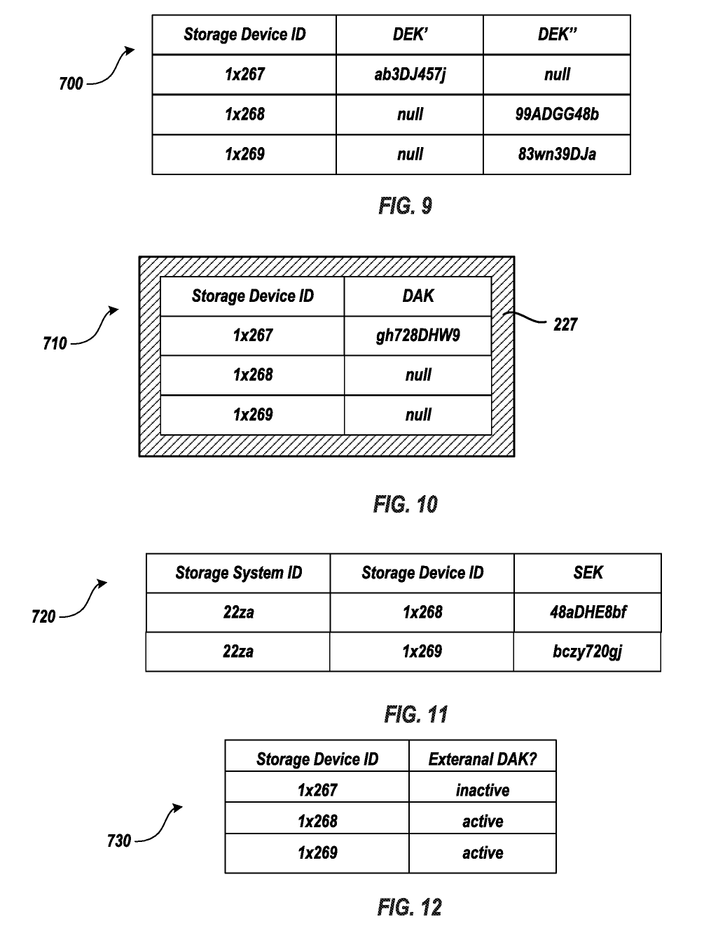

FIG. 9 illustrates an exemplary data structure 700 that includes storage device identifier information and an associated DEK′ and that is stored within an assisting storage device 225c within the storage system 132, according to various embodiments of the invention. Data structure 700 includes, for example, a storage device identifier “1x267” linked to DEK′ “ab3DJ457j”, storage device identifier “1x268” linked to DEK″ “99ADGG48b”, and storage device identifier “1x269” linked to DEK″ “83wn39DJa”. Encryption manager 268 may submit query including a storage device identifier against data structure 700 to obtain the linked DEK′ or DEK″, as appropriate. For example, encryption manager 268 may submit a query, against data structure 700, which includes storage device identifier “1x267” to obtain DEK′ “ab3DJ457j”, encryption manager 268 may submit a query, against data structure 700, which includes storage device identifier “1x268” to obtain DEK″ “99ADGG48b”, and encryption manager 268 may submit a query, against data structure 700, which includes storage device identifier “1x269” to obtain DEK″ “83wn39DJa”. For clarity, only one of a DEK′ or a DEK″ at any instance is linked to a storage device identifier within data structure 700 as the DEK′ is deleted from assisting storage device 225c upon the generation of DEK″.

FIG. 10 illustrates an exemplary data structure 710 containing storage device identifier information and an associated DAK and that is stored within an un-encrypted portion 227 of a storage device that contains user data (e.g., storage device 225a, 225b, or the like) within storage system 132, according to various embodiments of the invention. Data structure 710 includes, for example, a storage device identifier “1x267” linked to DAK “gh728DHW9”, storage device identifier “1x268” previously linked to a DAK that has since been deleted, and storage device identifier “1x269” previously linked to a DAK that has since been deleted. Encryption manager 268 may submit query including a storage device identifier against data structure 710 to obtain the linked DAK, as appropriate. For example, encryption manager 268 may submit a query, against data structure 710, which includes storage device identifier “1x267” to obtain DAK “gh728DHW9”. Upon the encryption manager 268 generating the DAK′, the DAK is deleted from data structure 710. For example, upon the generation of DAK′ associated with the storage device 225 identified by identifier “1x268”, the previously linked DAK to storage identifier 1x268″ is deleted from structure 710. Likewise, upon the generation of DAK′ associated with the storage device 225 identified by identifier “1x269”, the previously linked DAK to storage identifier 1x269″ is deleted from structure 710.

FIG. 11 illustrates an exemplary data structure 720 that includes storage system identifier information, storage device identifier information, and an associated SEK and that is stored within key server 300, according to various embodiments of the invention. Data structure 720 includes, for example, a storage system 132 identifier “22za” that identifies a particular storage system 132, a storage device identifier “1x268” linked to SEK “48aDHE8bf” and storage device identifier “1x269” linked to SEK “bczy720gj”. Encryption manager 268 may submit a request to key server 300 that includes a storage device identifier and key manager 364 may submit a query against data structure 720 with the storage device identifier to obtain the SEK that is linked thereto. For example, encryption manager 268 may submit a request to key server 300 that includes storage device identifier “1x268” and key manager 364 may submit a query against data structure 720 with the storage device identifier “1x268” to obtain SEK “48aDHE8bf” that is linked thereto. For clarity, a SEK is linked to a storage device identifier within data structure 720 upon the enrolment of the storage device with key server 300. For clarity, data structure 720 may not contain storage device identifier information when the key server 300 generates a single SEK for each storage device 225 within a particular storage system 132.

FIG. 12 illustrates an exemplary data structure 730 that includes storage device identifier information and an associated externally derived DAK indicator and that is stored within encryption manager 268, according to various embodiments of the invention. Data structure 730 includes, for example, a storage device identifier “1x267” linked to an inactive externally derived DAK indicator, a storage device identifier “1x268” linked to an active externally derived DAK indicator, and a storage device identifier “1x269” linked to an active externally derived DAK indicator. Upon the encryption manager 268 generating a DAK′ for the particular storage device the encryption manager 268 activates the externally derived DAK indicator bit that is linked to the applicable storage device identifier within data structure 730. In an embodiment, data structure 730 is generally stored in a memory 202 portion or storage device 225 area that is not utilized to store user data (i.e. data from any computer 100) and is a portion/area that stores data that is readable and/or writable by only storage system 132.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A storage system comprising:
a first storage device that stores user data received by one or more computers communicatively connected to the storage system;
a second storage device that does not store any user data received by any of the one or more computers communicatively connected to the storage system;
a processor and a memory comprising program instructions that are readable to cause the processor to:
prior to the first storage device being enrolled with an external key server and the storage system resultantly receiving a secure encryption key (SEK) assigned to the first storage device from the external key server:
encrypt the user data being stored upon the first storage device utilizing a device access key (DAK) and a device encryption key (DEK) by encrypting the DEK with the DAK to generate a DEK′, storing the DAK within the first storage device, storing the DEK′ within the second storage device, subsequently receiving the DAK from the first storage device and subsequently receiving the DEK′ from the second storage device, subsequently decrypting the DEK′ with the DAK to recover the DEK, and encrypting the user data being stored upon the first storage device utilizing the DEK; and
subsequent to the first storage device being enrolled with the external key server and the storage system resultantly receiving the SEK assigned to the first storage device from the external key server:
receive the DAK from the first storage device and receive the DEK′ from the second storage device, decrypt the DEK′ with the DAK to recover the DEK, generate a DAK′ from the first the SEK and a storage device identifier associated with the first storage device, encrypt the DEK with the DAK′ to generate a DEK″, and store the DEK″ within the second storage device.

2. The storage system of claim 1, wherein the first storage device is a self-encrypting device.

3. The storage system of claim 1, wherein the second storage device is a self-encrypting device.

4. The storage system of claim 1, wherein the processor is further configured to delete the DAK from the first storage device upon the generation of the DAK′.

5. The storage system of claim 1, wherein the processor is further configured to delete the DEK′ from the second storage device upon storing the DEK″ within the second storage device.

6. The storage system of claim 1, wherein the first storage device is a flash storage device.

7. The storage system of claim 1, wherein the DEK′ is stored within an un-encrypted portion of the second storage device.

8. A computer program product for a storage system hot encrypting user data being stored upon a first storage device that stores user data received by one or more computers communicatively connected to the storage system, prior to the first storage device being enrolled with an external key server and resultantly being assigned a secure access key (SEK), the computer program product comprising computer readable storage medium having program instructions embodied therewith, the program instructions are readable to cause a processor to:
prior to the first storage device being enrolled with the external key server and resultantly being assigned the SEK:
encrypt user data being stored upon the first storage device utilizing a first device access key (DAK) and a device encryption key (DEK) by encrypting the DEK with the DAK to generate a DEK′, storing the DAK within the first storage device, storing the DEK′ within a second storage device that does not store any user data received by any of the one or more computers communicatively connected to the storage system, subsequently receiving the DAK from the first storage device and subsequently receiving the DEK′ from the second storage device, subsequently decrypting the DEK′ with the DAK to recover the DEK, and encrypting the user data being stored upon the first storage device utilizing the DEK; and
subsequent to the first storage device being enrolled with the external key server and resultantly being assigned the SEK:
receive the DAK from the first storage device and receive the DEK′ from the second storage device, decrypt the DEK′ with the DAK to recover the DEK, generate a DAK′ from the first the SEK and a storage device identifier associated with the first storage device, encrypt the DEK with the DAK′ to generate a DEK″, and store the DEK″ within the second storage device.

9. The computer program produce of claim 8, wherein the first storage device is a self-encrypting device.

10. The computer program produce of claim 8, wherein the second storage device is a self-encrypting device.

11. The computer program produce of claim 8, wherein the processor is further configured to delete the DAK from the first storage device upon the generation of the DAK′.

12. The computer program produce of claim 8, wherein the processor is further configured to delete the DEK′ from the second storage device upon storing the DEK″ within the second storage device.

13. The computer program produce of claim 8, wherein the first storage device is a flash storage device.

14. The computer program produce of claim 8, wherein the DEK′ is stored within an un-encrypted portion of the second storage device.

15. A hot encryption method of a storage system comprising a first storage device that stores user data received by one or more computers communicatively connected to the storage system, a second storage device that does not store any user data received by any of the one or more computers communicatively connected to the storage system, the method comprising:
prior to the first storage device being enrolled with an external key server and the storage system resultantly receiving a secure encryption key (SEK) assigned to the first storage device from the external key server:
encrypting the user data being stored upon the first storage device utilizing a first device access key (DAK) and a device encryption key (DEK) by encrypting the DEK with the DAK to generate a DEK′, storing the DAK within the first storage device, storing the DEK′ within the second storage device, subsequently receiving the DAK from the first storage device and subsequently receiving the DEK′ from the second storage device, subsequently decrypting the DEK′ with the DAK to recover the DEK, and encrypting the user data being stored upon the first storage device utilizing the DEK; and
subsequent to the first storage device being enrolled with the external key server and the storage system resultantly receiving the secure encryption key (SEK) from the external key server:
receiving the DAK from the first storage device and receiving the DEK′ from the second storage device, decrypting the DEK′ with the DAK to recover the DEK, generating a DAK′ from the first the SEK and a storage device identifier associated with the first storage device, encrypting the DEK with the DAK′ to generate a DEK″, and storing the DEK″ within the second storage device.

16. The method of claim 15, wherein the first storage device is a self-encrypting device.

17. The method of claim 15, wherein the second storage device is a self-encrypting device.

18. The method of claim 15, further comprising:
deleting the DAK from the first storage device upon the generation of the DAK′.

19. The method of claim 15, further comprising:
deleting the DEK′ from the second storage device upon storing the DEK″ within the second storage device.

20. The method of claim 15, wherein the DEK′ is stored within an un-encrypted portion of the second storage device.
